(19) United States
(12) Patent Application Publication
(10) Pub. No.: US 2026/0080878 A1
(43) Pub. Date: Mar. 19, 2026

(54) VOICE-BASED USER AUTHENTICATION

(71) Applicant: QUALCOMM Incorporated, San Diego, CA (US)

(72) Inventors: Hesu HUANG, San Diego, CA (US); Zhijia SUN, Shenzhen (CN); Xiaoxia DONG, Shenzhen (CN); Jun WEI, Shenzhen (CN)

(21) Appl. No.: 19/108,413

(22) PCT Filed: Oct. 14, 2022
(86) PCT No.: PCT/CN2022/125304

§ 371 Date: Mar. 3, 2025

(51) Int. Cl. G10L 17/06; G10L 17/24

(52) U.S. Cl. CPC G10L 17/06; G10L 17/24

(57) ABSTRACT

Disclosed are systems, apparatuses, processes, and computer-readable media to capture audio. A method of processing audio data includes obtaining first audio information from a user using an audio sensor of a user device; determining whether the first audio information includes audio corresponding to a detected keyword that configures the user device to receive or process one or more commands from the user; based on the first audio information including the audio corresponding to the detected keyword, determining a similarity between the first audio information corresponding to the detected keyword and a model of an authenticated user; and determining whether to authenticate the user as the authenticated user based on a comparison of the similarity between the first audio information and the model of the authenticated user to a first threshold.

### FIELD

The present application is generally related to processing audio data. For example, aspects of the present disclosure relate to systems and techniques for providing improvements (e.g., latency reduction) for voice-based (e.g., text-independent) user authentication (also referred to as user verification).

### BACKGROUND

Electronic devices (e.g., mobile devices and other electronic devices) can communicate audio (e.g., speech or voice) and data packets over wireless networks. Such devices can also provide additional functionality via one or more applications, such as capturing images using a digital still camera, capturing video using a digital video camera, recording data (e.g., audio, image data, video, etc.) using a digital recorder, outputting audio (e.g., streaming music or a music file, book content, etc.) using an audio player, and/or other functionalities. Some electronic devices can be configured to process speech or voice input for various purposes. For example, a speech recognition application, such as a virtual digital assistant, of an electronic device can translate spoken speech commands into functions or actions that are to be performed by one or more other applications of the device (e.g., an audio file player, etc.). In some cases, an electronic device can perform user authentication or verification to authenticate/verify an identify a user based on voice or speech characteristics, such as to determine whether the user is an authorized user of the device.

In some cases, there can be latency issues when performing user authentication/verification based on voice or speech. For example, the user authentication or verification application may provide more accurate user authentication/verification results when processing speech with longer durations. However, the user authentication or verification application may experience more latency when processing the longer duration speech.

### SUMMARY

In some examples, systems and techniques are described for authenticating a user of an electronic device using voice input (e.g., using text-independent speech analysis). The systems and techniques can reduce latency associated with user authentication based on voice input.

According to at least one example, a method is provided for processing audio. The method includes: obtaining first audio information from a user using an audio sensor of a user device; determining whether the first audio information includes audio corresponding to a detected keyword that configures the user device to receive or process one or more commands from the user; based on the first audio information including the audio corresponding to the detected keyword, determining a similarity between the first audio information corresponding to the detected keyword and a model of an authenticated user; and determining whether to authenticate the user as the authenticated user based on a first comparison of the similarity between the first audio information and the model of the authenticated user to a first threshold.

In another example, an apparatus for processing audio is provided that includes at least one memory and at least one processor coupled to the at least one memory. The at least one processor is configured to: obtain first audio information from a user using an audio sensor of a user device; determine whether the first audio information includes audio corresponding to a detected keyword that configures the user device to receive or process one or more commands from the user; based on the first audio information including the audio corresponding to the detected keyword, determine a similarity between the first audio information corresponding to the detected keyword and a model of an authenticated user; and determine whether to authenticate the user as the authenticated user based on a first comparison of the similarity between the first audio information and the model of the authenticated user to a first threshold.

In another example, a non-transitory computer-readable medium is provided that has stored thereon instructions that, when executed by one or more processors, cause the one or more processors to: obtain first audio information from a user using an audio sensor of a user device; determine whether the first audio information includes audio corresponding to a detected keyword that configures the user device to receive or process one or more commands from the user; based on the first audio information including the audio corresponding to the detected keyword, determine a similarity between the first audio information corresponding to the detected keyword and a model of an authenticated user; and determine whether to authenticate the user as the authenticated user based on a first comparison of the similarity between the first audio information and the model of the authenticated user to a first threshold.

In another example, an apparatus for processing audio is provided. The apparatus includes: means for obtaining first audio information from a user using an audio sensor of a user device; means for determining whether the first audio information includes audio corresponding to a detected keyword that configures the user device to receive or process one or more commands from the user; based on the first audio information including the audio corresponding to the detected keyword, means for determining a similarity between the first audio information corresponding to the detected keyword and a model of an authenticated user; and means for determining whether to authenticate the user as the authenticated user based on a first comparison of the similarity between the first audio information and the model of the authenticated user to a first threshold.

In some aspects, the apparatus is, is part of, and/or includes a mobile device (e.g., a mobile telephone and/or mobile handset and/or so-called “smartphone” or other mobile device), an extended reality (XR) device (e.g., a virtual reality (VR) device, an augmented reality (AR) device, or a mixed reality (MR) device), a head-mounted device (HMD) device, a vehicle or a computing system, device, or component of a vehicle, a wearable device (e.g., a network-connected watch or other wearable device), a wireless communication device, a camera, a personal computer, a laptop computer, a server computer, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a conceptual diagram of a voice input device that incurs latency due to delayed authentication of voice input.

FIG. 2 is block diagram of a voice input device that reduces latency by improving authentication of voice input in accordance with some aspects of the disclosure.

FIG. 3 is a flowchart of a process performed by a voice input device that reduces latency in accordance with some aspects of the disclosure.

FIGS. 4A and 4B are timing diagrams that illustrate different voice authentication scenarios in accordance with aspects of the disclosure.

FIG. 5 is an illustration of a speaker device that includes voice input functions to authenticate a user in accordance with some aspects of the disclosure.

FIG. 6 is an illustration of a mobile device that includes voice input functions to authenticate a user in accordance with some aspects of the disclosure.

FIG. 7 is an illustration of an automated cleaning device 700 that includes voice input functions to authenticate a speaker in accordance with some aspects of the disclosure.

FIG. 8 is a flowchart illustrating an example of a method 800 for processing audio data, in accordance with certain aspects of the present disclosure.

FIG. 9 is a diagram illustrating an example of a system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The ensuing description provides example aspects only, and is not intended to limit the scope, applicability, or configuration of the disclosure. Rather, the ensuing description of the exemplary aspects will provide those skilled in the art with an enabling description for implementing an aspect of the disclosure. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As noted previously, electronic devices may be configured to receive audio input (e.g., speech or voice input) and intelligently process the audio input to perform one or more functions, such as controlling the device, causing the device to output audio content (e.g., music content, book content, etc.), control an auxiliary device or system such as a lighting system that is connected (e.g., wirelessly connected) to the voice input device, and so forth. Such electronic devices can be referred to as a voice input device. In some aspects, the application utilized by a voice input device to process audio input may be referred to as a voice assistant. Examples of a voice input device include a mobile phone, an XR device (e.g., a VR device, AR device, and/or MR device), a vehicle or system, device, or component of the vehicle, a tablet computer, a television (TV), an external TV input device (e.g., Roku™, etc.), a smart speaker, a laptop computer, a desktop computer, or any other suitable electronic device.

In some cases, a voice input device can be placed in a low power state. While in the low power state, the voice input device can monitor an environment for speech related to a keyword. For example, a voice input device may be configured to wake up and shift to a higher power state after detecting a keyword in a speech input. In some cases, the voice input device can provide feedback (e.g., audio feedback, visual feedback such as using a display, one or more lights or other visual feedback, etc.) to indicate that a voice assistant of the voice input device is active. For example, after a user speaks a keyword configured to activate the voice assistant of the voice input device, the voice input device can illuminate lights integral to the device and/or provide an audio output to indicate that the voice input device is waiting for additional input (e.g., referred to as a command) from the user. If a command (e.g., a voice or speech command) is received from the user, the voice assistant can cause one or more applications to be activated (e.g., a music application, an application for controlling an auxiliary device or system, etc.). In some cases, the initial speech input can include a keyword and a command, in which case the voice input device (e.g., the voice assistant) can process the keyword and subsequently (e.g., after entering the higher power state) process the command if the keyword is identified.

Voice input devices can also be configured to verify or authenticate a user from which voice or speech input is received, which can be referred to as user verification or user authentication. User verification or authentication is the process of verifying that the user corresponds to an enrolled identity (e.g., a user profile) of the voice input device and/or voice assistant. Once verified or authenticated, the voice input device and/or voice assistant can enable the user to engage in activities that are authorized by that user, such as accessing one or more applications (e.g., a music application, an application for controlling an auxiliary device or system, etc.).

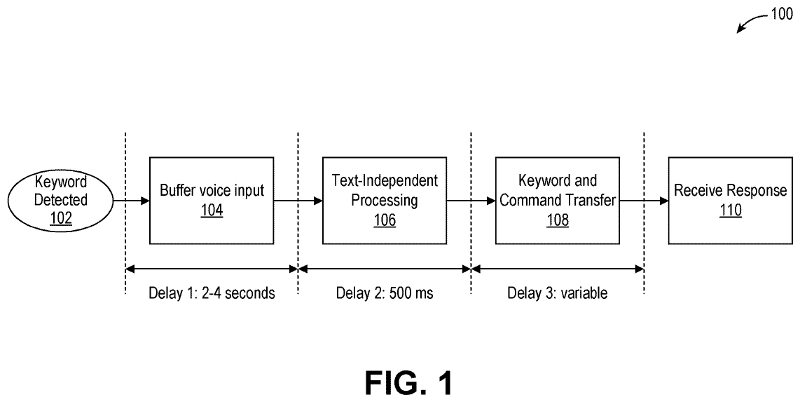

Authenticating a user using voice or speech input that is independent of one or more pre-defined keywords is a complicated process and may require a significant amount of processing power. In addition, authenticating the user based on voice or speech input that includes a detected keyword and a subsequent voice or speech command may result in significant latency. For example, the user authentication or verification application may provide more accurate user authentication/verification results when processing speech (e.g., a keyword and a subsequent command) with longer durations. However, processing such longer durations of voice or speech input may cause a user authentication or verification application to experience more latency. As further described with reference to FIG. 1, the entire verification/authentication process using a voice input device can take a significant amount of time (e.g., 500 milliseconds (ms), 1 second, etc.), resulting in an application (e.g., a music application, an application for controlling an auxiliary device or system, etc.) not receiving the user verification/authentication result and corresponding command to process until an even longer period of time (e.g., 2 seconds, 3 seconds, 4 seconds, etc.). Such latency can result in a noticeable and inconvenient delay for the user.

In some aspects, systems, apparatuses, processes (also referred to as methods), and computer-readable media (collectively referred to herein as “systems and techniques”) are described for improving voice-based user authentication or verification (e.g., text-independent user authentication or verification). The systems and techniques can perform a two-stage user authentication or verification process, which can be a text-independent user authentication or verification process in some cases. For instance, the systems and techniques can determine whether obtained first audio information includes audio corresponding to a detected keyword (e.g., a keyword that was previously detected as a valid keyword) that configures the user device to receive or process one or more commands from the user. In one aspect, the first audio information can correspond to a detected keyword associated with the user device (e.g., a text-independent keyword created by a user of the user device), and, based on the first audio information including the audio corresponding to the detected keyword, the systems and techniques can determine a similarity between the first audio information corresponding to the keyword and a model of an authenticated user. In one illustrative aspect, the model is trained by an authenticated user.

After determining a similarity between the first audio information corresponding to the detected keyword and a model of an authenticated user, the systems and techniques can determine whether to authenticate the user as the authenticated user based on a first comparison of the similarity between the first audio information and the model of the authenticated user to a first threshold. For example, if the similarity is greater than the first threshold, the systems and techniques can authenticate the user as the authenticated user at this time without input of a command or query for the systems and techniques.

In another illustrative aspect, when the similarity between the first audio information and the model of the authenticated user is less than the first threshold, the systems and techniques can obtain second audio information that follows the first audio information and includes a command or query. The systems and techniques can determine a similarity between the second audio information (and in some cases a combination of the first audio information and the second audio information) and the model of the authenticated user. The system and techniques determine whether to authenticate the user as the authenticated user based on a second comparison of the similarity between the second audio information (and in some cases the combination of the first audio information and the second audio information) and the model of the authenticated user to a second threshold that is different from the first threshold. In some cases, the similarity can be based on a portion of the second audio information having a maximum duration (e.g., based on a timer). For instance, the systems and techniques can use a portion of the command or query, such as two seconds of the command or query, and authenticate the user as the authenticated user while the command or query is continuing to be input. In some aspects, the systems and techniques reduce latency of user authentication (e.g., based on authenticating the user based only on the detected keyword included in the first audio information) and in some cases can provide visual feedback to improve the voice input capabilities.

In one illustrative example, a keyword detection engine of a system can receive as input audio samples (e.g., pulse code modulation (PCM) data from one or more microphones) and can determine whether a target keyword is included in the audio input. In some cases, a trained neural network keyword-detection model can be used to determine if the audio data includes the keyword. The audio samples are determined to include the keyword, the audio samples can be stored in a detected keyword buffer. Further, if the keyword is detected, the system can use the audio samples in the detected keyword buffer to begin a first stage of a two-stage text-independent user verification process. In the first stage, the system can compare the features extracted from the detected keyword audio samples with an enrolled/registered user model to determine if the keyword is uttered by the target/registered user (which can be referred to as an authorized user). For example, if a similarity (e.g., user voice confidence score) between the keyword audio samples and the model is above the first threshold noted above, the system can determine with high confidence that the user is the authorized user only using the keyword audio samples. In such cases, the system can stop the verification/authentication process, and can start to transfer follow-up data (e.g., a command) to upper layers such as client applications. Using only the keyword audio samples can greatly reduce the user verification/authentication process, thus reducing the end-to-end latency of voice activation because the system does not need to wait for an audio command to make the decision for the keyword and for the authorized user. However, if the user voice confidence score is not high enough (e.g., the similarity is less than the first threshold), the system may not have sufficient confidence to confirm whether it is the authorized user that is speaking. The system can then proceed to obtain the follow-up command speech audio samples (when available) and perform the second stage of the two-stage text-independent user verification process.

In some cases, a voice activation system may not utilize text-independent user verification or authentication and may instead use keyword-dependent user verification or authentication. For example, initial voice activation can perform keyword detection and keyword-dependent user verification concurrently using the same keyword-only audio samples. Such a key-word dependent voice activation system does not use command audio samples (e.g., audio samples including a command occurring after audio samples including a keyword). Such a voice activation system may require that, during an enrollment stage, the user enrollment has to be the same keyword from the same user repeated a certain number of times (e.g., five times) to create the user voice model. During a detection stage, the keyword buffer audio data can be processed for keyword detection and also for user verification.

In some cases, a user verification system may be extended to support text-independent user verification or authentication. In such cases, during an enrollment stage, the user enrollment may use random speech samples (not including a keyword) from the same target user (e.g., five commands/sentences read by the target user) to create the user voice model. During detection stage, the keyword and command can be used for user verification/authentication. However, such a system may have a large end-to-end latency.

As noted above, the systems and techniques described herein can reduce the end-to-end latency for a voice activation system to support user verification or authentication (e.g., text-independent user verification or authentication). For example, instead of waiting until audio samples including a keyword and also audio samples including a command are all completed by the user to start with user authentication, the systems and techniques can perform the first stage of the two-stage verification/authentication process using keyword audio samples from the keyword sample buffer only, and, if the confidence using the keyword audio samples is high (e.g., greater than the first threshold), the system can authenticate/verify the user (while also determining that the keyword is detected), without waiting until the command completes to start the user verification/authentication process.

Additional details and aspects of the present disclosure are described in more detail below with respect to the figures.

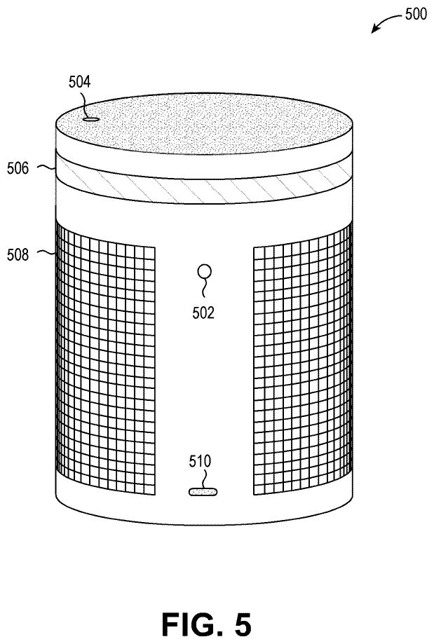

FIG. 1 is a conceptual diagram 100 of inputting voice commands into a voice input device that incurs latency due to delayed authentication. As used herein, the term “voice” and “speech” are used interchangeably. A voice input device may be configured to receive voice input and perform various actions based on that input. An illustrative example of a voice input device is a smart speaker, which is capable of outputting audio and is programmable with other functions or can be operated using voice input. Other illustrative examples of voice input devices include a mobile device (e.g., a mobile telephone), an XR device, a system or component (e.g., a media system) of a vehicle, or other device. The voice input device may also be configured to connect to another electronic device to be programmed or configured using a graphical user interface. An example of a smart speaker is illustrated in FIG. 5. Illustrative examples of voice input devices are further illustrated in FIGS.-6 and 7.

To operate the voice input device, a voice command is provided from a user and received by the voice input device. The voice command can include a keyword. In some cases, the keyword can be user defined, in which case the user can define the keyword (and is not pre-defined by the manufacturer of the device) during an enrollment or setup stage of the device. The text-independent authentication does not require specific keywords to verify the authentication of the user. For example, the user may be able to customize the keyword, such as selecting different possible keywords, or providing a custom keyword. In some examples, the keyword can be customized by the user through a user interface of a device connected to the voice input device by, for example, selecting a keyword or another method of inputting a keyword (e.g., by providing a speech input defining the keyword).

The voice input device can be configured to receive audio data (including speech input) using an audio sensor (e.g., a microphone) and monitor the audio data for a keyword at block 102. In some cases, the voice input device can monitor for the keyword while in a low power state. In some examples, the voice input device can buffer the audio data. The voice input device can analyze the audio data to determine if the keyword is detected. In some examples, the keyword can be identified by comparing a known pattern to the voice command to ascertain whether the speech corresponds to the keyword.

If the keyword is detected at block 102, the voice input device can obtain a second voice input (e.g., received as part of the same phrase including the keyword or received after prompt by the voice input device after the keyword is detected). The voice input device can buffer the second voice input at block 104. In some cases, the voice input device can enter a higher power state after detecting the keyword. In some aspects, the second voice input can be a command, such as a function to perform (e.g., start a timer, play music, etc.). In another aspect, the second voice input can be a query for information from the user (e.g., a request for the present time). The second voice input can be buffered so that the voice input device receives enough of the command to perform user authentication or verification. In one illustrative example, the second voice input (e.g., the command) can include between two and four seconds. The second voice input may be longer due to complex queries and pauses in speech. As illustrated in FIG. 1, the second voice input creates a first delay that varies in time based on the complexity of the second voice input.

After the second voice input is buffered the voice input device is configured to perform, at block 106, text-independent user authentication or verification using the second voice input (and in some cases the keyword and the first voice input) to determine if the voice input corresponds to a user. In one aspect, the voice input device may store a voice model of the user's speech based on an enrollment or training process. The voice model can include characteristics of the user's speech. For example, the voice model may include the pitch (e.g., pitch frequency), formant (e.g., formant frequency), and/or other characteristics of the user's voice based on voice provided by the user during the enrollment or training process. The voice model may compare the voice input at block 104 to the voice model to authenticate that the user (e.g., the person who provides the voice input) corresponds to the model of the user's speech.

The text-independent processing based on the second voice input (e.g., the command) and in some cases the keyword can consume a significant amount of time and may require comparison of a complex data object to the voice model. The delay incurred by the text-independent processing at block 106 is also variable depending on the length of the voice input, noise quality (e.g., a signal-to-noise (SRN) ratio) of the voice input, and other factors. For example, a text-independent processing duration of 500 milliseconds (ms) may be incurred in some cases.

After authenticating the user, the voice input device is configured to provide at least the second voice input at block 108 to an application (e.g., a music application, a timer, etc.). In some cases, the voice input device can process the second voice input using a translation application to convert the speech into machine readable content (e.g., word vectors, text, etc.) and disambiguate the meaning of the second voice input. In one aspect, the translation service may be an automatic speech recognition (ASR) or natural language processing (NLP) function that converts inputs into machine readable content. For example, NLP provides tokens (e.g., a single word) that identify relationships of text within the second voice input. The second voice input may be processed by the voice input device and/or a cloud service to disambiguate the meaning of the second voice input. In some aspects, the cloud service is used to disambiguate the meaning of the second voice input because the translation service can use a dictionary with words represented by multi-dimensional vector (e.g., 768 dimensions for current NLP dictionaries) that consumes a substantial storage space and is continually changing based on further training. In other cases, the dictionary can be stored locally on the device. The voice input device may preprocess the audio data, for example, perform local filtering and downsampling to reduce the size of the audio data. The providing of the second audio input at block 108 is also variable depending on the techniques employed and the complexity of the language. In some cases, the voice input device may provide the first audio input (e.g., the keyword) and the second audio input (e.g., the command) to the translation service.

At block 110, the voice input device is configured to receive a response associated with the second voice input and may then act on the second voice input. For example, the response associated with the second voice input can be provided to an application executing in the voice input device, such as a multimedia application that is playing audio.

As illustrated in FIG. 1, the voice input device can have a significant amount of delay and the authentication of the user command may create time durations in which the voice input device is processing the voice input, but is unable to perform the intended function requested by the user. Delays of a second can compound a user's frustrations and may result in inconvenience for the user. For example, if the user requests a voice input device for information, and the voice input device consumes three seconds of time and then informs the user that their voice input is not authenticated (e.g., as a result of a noisy environment with a low SNR), the delay can encourage a user to avoid using voice input.

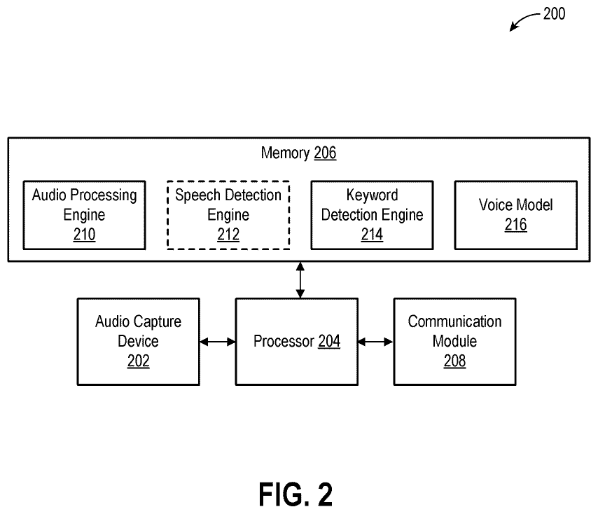

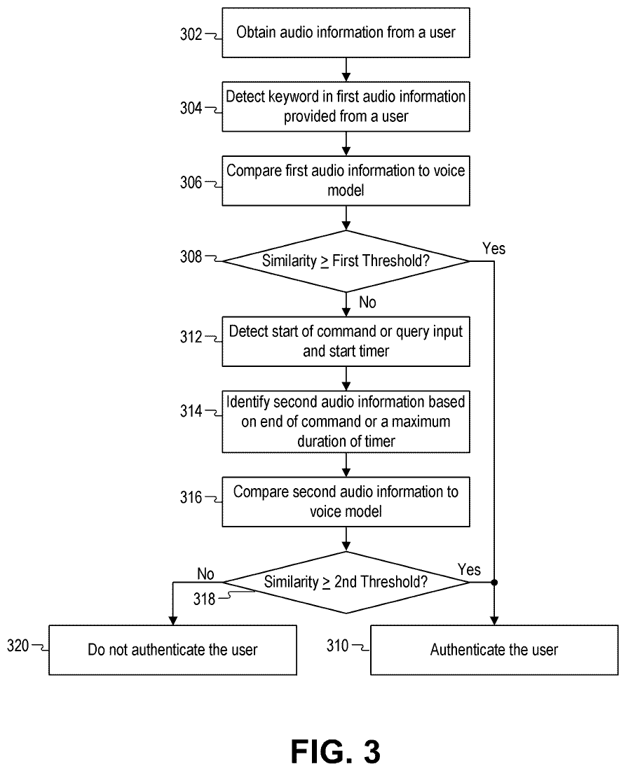

FIG. 2 is a block diagram of a voice input device 200 that reduces latency by improving authentication of voice input in accordance with some aspects of the disclosure. The voice input device 200 can perform a two-stage text-independent user verification process (e.g., the process 300 of FIG. 3). The voice input device includes an audio capture device 202, a processor 204, a memory 206, and a communication module 208.

The audio capture device 202 is configured to obtain sound within the environment of the voice input device 200 and convert the sound into audio information (e.g., audio data). An example of an audio capture device 202 is a microphone, such as an audio transducer. In some cases, the voice input device 200 can include multiple audio capture devices 202 to improve the audio fidelity of the audio information. The processor is configured to receive instructions that are stored within the memory 206 and execute the instructions.

In one aspect, the memory 206 can store an audio processing engine 210 that is configured to process the audio according to various aspects of the disclosure. The memory may include a speech detection engine 212 that is configured to recognize audio information that may include speech by a user. In some cases, the speech detection engine 212 can recognize the enunciated words in the voice input and convert the words into text (e.g., speech-to-text synthesis). As noted above, some devices may omit a speech detection engine because high-fidelity models are more suitable to be stored on a server for continued training and based on the size of the dictionary of multi-dimensional vectors. The voice input device 200 may also include a keyword detection engine 214 that is configured to detect or identify the keyword based on a pattern. For example, the pattern can be represented by a spectral analysis over a period of time.

The voice input device 200 can also store a voice model 216 that can be trained by a user of the voice input device 200 during an enrollment process or stage. For example, during the enrollment process, the voice input device 200 may request the user to provide voice input to the device, and the voice input device 200 or another device (e.g., a cloud computation device) can analyze the voice input to identify characteristics or patterns (e.g., pitch, formant, etc.) that are indicative of the user's speech patterns.

The voice input device 200 also includes a communication module 208 that is configured to transfer data across a physical interface (e.g., a wireless communication link) to perform various communication functions. The communication module can include short range (e.g., Bluetooth low energy (BLE), Wi-Fi, etc.) communication circuits and long range (e.g., cellular) communication circuits.

In some aspects, the audio processing engine 210 may include logic functions to control the text-independent user authentication at the voice input device 200. In one illustrative aspect, the audio processing engine 210 may be configured to perform the two-stage text-independent user verification process on the voice input. For example, the audio processing engine 210 includes instruction for the processor 204 to perform the text-independent user verification based on comparing the voice input that includes the detected keyword (e.g., a previously-detected keyword) to the voice model 216 associated with a user of the voice input device 200 (corresponding to a first stage of the two-stage text-independent user verification process). The comparison can generate a similarity using an integer or a floating point value, and the audio processing engine 210 includes instructions for the processor 204 to compare the similarity to a first threshold. If the similarity of the voice input including the detected keyword is higher or equal to the first threshold, the audio processing engine 210 includes instructions for the processor 204 to determine that the voice input including the detected keyword corresponds to the user. Such a similarity determination is separate from detecting the keyword, and relates to authenticating that the user is an authenticated user (e.g., for text-independent user verification).

In response to determining that the voice input including the detected keyword corresponds to the user, the audio processing engine 210 may include instructions for the processor 204 to authenticate the user and be configured to process subsequent voice input before receiving the subsequent voice input (e.g., before receiving the command). For example, when the user speaks the detected keyword in a low noise environment, the processor 204 can identify the similarity of the voice input to the voice model 216 is 0.95, which indicates a high correlation, and is greater than a first threshold of 0.9. The value of the first threshold is an example and can be configured based on the device. For example, a smart speaker may have a lower first threshold than a mobile device.

In some aspects, the audio processing engine 210 may include instructions for the processor 204 to provide an indicator to identify authentication of the user. For example, the processor 204 may authenticate the user, and may then provide a command to an executing application to indicate that the voice that provided the speech is authenticated, and the application can provide instructions to change the visual indicator to indicate authentication. An example of a visual indicator can be a dot within a graphical user interface, which can change colors from red to green to indicate authentication or can be a hardware component such as an LED light that is changed to output green to indicate authentication. The output of the visual indicator provides visual feedback to the user that can be easily understood and inform the user that the subsequent voice input will be processed.

In some other aspects, if the processor 204 does not authenticate the user based on the voice input including the detected keyword, the audio processing engine 210 may include instructions for the processor 204 to capture a portion of voice input that includes a query or a command (e.g., for a second stage of the two-stage text-independent user verification process). The entire query or command can take consume several seconds of voice input in time, and the audio processing engine 210 may include instructions for the processor 204 to perform the authentication using a maximum amount of time (e.g., 3 seconds of voice input), which enables the processor 204 to perform the authentication in parallel with continuing to receive the voice input. For example, the voice input device may be configured to buffer the voice input using a stream and can process the data as the stream is being received, rather than waiting for the entire voice input and then processing the entire voice input at one time. This example allows the voice input device to continue to receive the voice input and may provide a portion of that voice input for authentication based on a second comparison to the voice model 216.

The second comparison also generates a second similarity using an integer or a floating point value, and the audio processing engine 210 includes instructions for the processor 204 to compare the second similarity to a second threshold. If the second similarity is higher or equal to the second threshold, the audio processing engine 210 includes instructions for the processor 204 to determine that the voice input including the command or query corresponds to the user. In this case, the comparison of the voice input is more robust and can more accurately provide a thorough comparison to the voice model 216. The second threshold can therefore be lower to tolerate higher noise environments or conditions that may affect the audio quality of the voice input obtained by the audio capture device 202.

In this case, the voice input device 200 is configured to perform the authentication during the input of the command or query, which can reduce the latency of the authentication of the user. As described above, the voice input device 200 may also be configured to provide visual feedback in a graphical user interface or another visual indicator to inform the user that their identity has been authenticated based on voice input. In some aspects, the voice input associated with the command or query may be less than the maximum amount of time, and the voice input device 200 can perform the authentication of the entire voice input associated with the command or query.

FIG. 3 is a flowchart illustrating an example of a method 300 for processing audio data, in accordance with certain aspects of the present disclosure. The method 300 can be performed by a computing device having an audio sensor, such as a mobile wireless communication device, a smart speaker, a camera, an XR device, a wireless-enabled vehicle, or another computing device. In one illustrative example, a computing system 900 can be configured to perform all or part of the method 300.

At block 302, a computing device (e.g., a smart speaker, a mobile communication device, etc.) is configured to obtain audio from a user. In one illustrative aspect, the computing device may be in a low power mode and is configured to buffer audio and then enter a higher power mode to determine if detected audio corresponds to a keyword. The computing device may include an analog-to-digital converter (ADC) to convert received sound into first audio information. The computing device may also perform filtering to remove unnecessary information in the first audio information, such as noise and higher frequencies, and so forth.

At block 304, the computing device detects the keyword in audio provided by a user. For example, the computing device may include a predetermined model that corresponds to the keyword and performs a comparison of the model to the audio to determine whether the keyword is detected within the first audio information. In some cases, the model may be at least partially trained during a training phase of the computing device.

At block 306, the computing device compares the first audio information to a voice model (e.g., voice model 216). As described above, the voice model is configured during training when a user reads content into the computing device and the computing device identifies patterns of speech that are unique to the user. The comparison at block 306 produces a similarity, or a correlation, that identifies the likelihood that the first audio information corresponds to the voice model.

At block 308, the computing device determines whether the similarity is greater than a first threshold. In some aspects, the first threshold is a value that has a high correlation with a smaller quantity of audio corresponds to the voice model of the user. For example, a value can be empirically determined that indicates that even if additional audio information is obtained, the additional audio information would likely not reduce substantially reduce the similarity. If the similarity is greater than or equal to the first threshold, the computing device may proceed to block 310.

At block 310, the computing device determines that the user (e.g., the speaker providing voice input) corresponds to the user and authenticates the user. In some aspects, at block 310, a visual indication of user authentication can be output by the computing device. Referring back to block 308, if the similarity is less than the first threshold, the computing device may proceed to block 312.

At block 312, the computing device continues obtaining audio information, which is referred to as second audio information for purposes of clarity. In one aspect, at block 312, the computing device can detect the input of additional voice information and detect the start of a command or query for the computing device. In addition, the computing device starts a timer in response to detecting the command or query.

At block 314, the computing device identifies second audio information from audio information obtained based on either ending the command or query or a maximum duration of the timer. For example, if the maximum duration of the timer is 2 seconds, the computing device can extract a portion from the obtained audio information corresponding to the maximum duration of the timer. In another example, if the command or query ends before the maximum duration of the timer, the computing device may use the entire obtained portion of the audio information as the second audio information.

At block 316, the computing device compares the second audio information to the voice model (e.g., voice model 216). In some aspects, the comparison at block 316 produces a second similarity, or a correlation, that identifies the likelihood that the second audio information corresponds to the voice model.

At block 318, the computing device determines whether the second similarity is greater than a second threshold. In some aspects, the second threshold is less rigorous than the first threshold because the duration of the second audio information is significantly longer than the first threshold, which can provide an accurate determination at lower values. If the second similarity is greater than or equal to the second threshold, the computing device may proceed to block 310 to authenticate the user. However, if the second similarity is less than the second threshold, the computing device may proceed to block 320. At block 320, the computing device determines that the voice input does not correspond to the user, and does not authenticate the user.

As noted above, in response to the authenticating the user, the computing device can enable authorized functions based on the voice input. For example, in the illustrative example of a mobile communication device, the mobile communication device can authenticate the user to perform voice input, such as dialing a particular contact or sending a text message to the particular contact.

Although the foregoing aspects describe a single voice model for a single user, the foregoing aspects can include a plurality of voice models. For example, the smart speaker can be configured to authenticate different users and the different users can have different authorizations (e.g., access permissions).

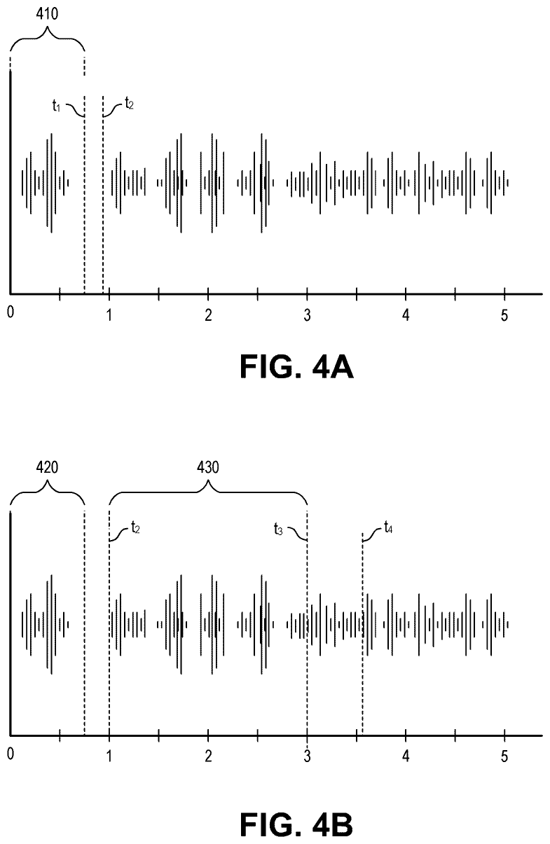

FIGS. 4A and 4B are timing diagrams that illustrate different voice authentication scenarios in accordance with aspects of the disclosure;

FIG. 4A illustrates a first example of user authentication that is performed by a computing device. Various examples of computing devices are further described herein with reference to FIGS. 5, 6, and 7. In FIG. 4A, the computing device receives a first voice input 410 beginning at time 0 seconds and ends at time t₁. In this illustrative aspect, the computing device compares the first voice input 410 to the keyword to determine that the first voice input 410 corresponds to the keyword. After identification of the keyword, the computing device then compares the first voice input 410 to a voice model associated with the user (e.g., voice model 216) and determines, at time t₂, that the similarity of the first voice input (e.g., 95%) to the voice model is less than a first threshold (e.g., 90%). Based on the comparison, the computing device then authenticates the user.

In this illustrative aspect, the voice authentication using the first voice input significantly reduces latency.

FIG. 4B illustrates a second example of user authentication that is performed by a computing device. In FIG. 4B, the computing device receives a first voice input 420 beginning at time 0 seconds and ends at time t₁. In this illustrative aspect, the computing device compares the first voice input 420 to the keyword to determine that the first voice input 420 corresponds to the keyword. After identification of the keyword, the computing device then compares the first voice input 420 to a voice model associated with the user (e.g., voice model 216) and determines that the similarity of the first voice input 420 to the voice model (e.g., 75%) is greater than a first threshold (e.g., 90%).

At time t₂, the computing device begins receiving a second voice input (starting at time t₂) that corresponds to a command or a query for the computing device. In this aspect, the computing device may start a timer that has a maximum duration that is configured to optimize the comparison of voice input to the voice model. The computing device continues to obtain the voice input and at time t₃, the computing device determines that the value of the timer corresponds to the maximum duration of the timer. The computing device can extract a portion 430 of the second voice input and compare the portion 430 of the second voice input with the voice model. At time t₄, the computing device determines that the similarity of the portion 430 of the second voice input (e.g., 83%) to the voice model is greater than a second threshold (e.g., 70%). In some aspects, the portion 430 of the second voice input can also include the first portion 420 for the second comparison.

In FIG. 4B, at time t₄, the user is continuing to provide voice input. After the voice input is finished as illustrated in FIG. 4B, the computing device may then transmit the second portion 430 of the second voice input (or the entire second voice input in some cases) to a cloud service to perform speech recognition. If the user is not authenticated, the illustrative examples would not perform any further processing of the voice input because the user is not authenticated and therefore not authorized to perform any functions associated with the computing device.

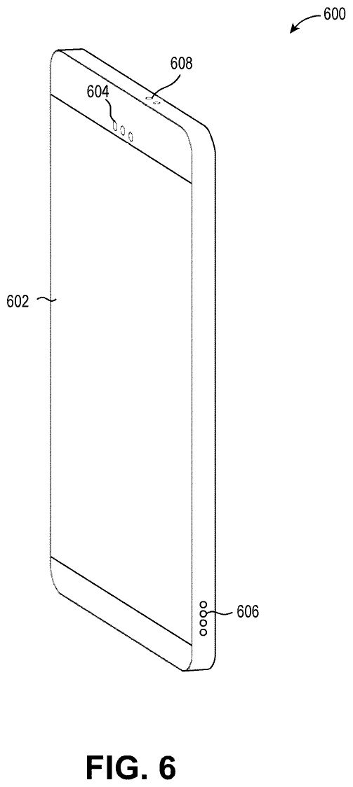

FIG. 5 is an illustration of a speaker device 500 that includes voice input functions to authenticate a speaker in accordance with some aspects of the disclosure. In some aspects, the speaker device 500 may include a voice assistant function to enable voice input to provide convenient control over the speaker device 500. The speaker device 500 includes at least one audio capture device 502 that is disposed on a lateral side of the speaker device 500. The speaker device 500 may also include an audio capture device 504 that is positioned on a top surface. In some aspects, the speaker device 500 may include a visual indicator 506 to provide visual output to identify that speaker device 500 is actively monitoring for voice input, such as a command or query. The visual indicator 506 may also provide visual distinctions to indicate whether the user is authenticated or not authenticated. For example, the visual indicator 506 may illuminate orange to indicate the user is not authenticated and may illuminate green to indicate that the user is authenticated. The speaker device 500 also includes at least one audio transducer 508 to output audio to the user, such as playing music or providing audio prompts. The speaker device may also include at least one port 510 for connecting to a power supply or another computing device. Although the example of FIG. 6 illustrates a USB type C port, the port can be an analog stereo jack, or other analog or digital connector.

FIG. 6 is an illustration of a mobile communication device 600 that includes voice input functions to authenticate a speaker in accordance with some aspects of the disclosure. In some aspects, the mobile device includes a display 602 and a plurality of forward-facing sensors 604. In one aspect, the forward facing sensor 604 can include an audio capture device. The mobile communication device 600 may also include an audio capture device at various locations, such as the audio capture device 606 located on a lateral side, and the audio capture device 608 located on a top surface. The mobile communication device 600 may include a plurality of audio capture devices to allow the mobile communication device 600 to be used in a hands-free mode and to allow the user to provide voice input. For example, the hands-free mode can be used while the user is driving and should not operate the graphical user interface.

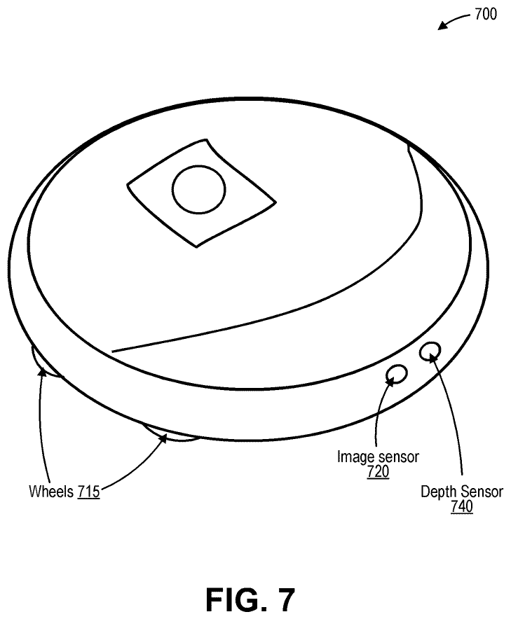

FIG. 7 is an illustration of an unmanned ground vehicle 700 such as an automated cleaning device that includes voice input functions to authenticate a speaker in accordance with some aspects of the disclosure. In some aspects, the unmanned ground vehicle 700 performs visual simultaneous localization and mapping (VSLAM) to autonomously navigate the environment.

The unmanned ground vehicle 700 includes an image sensor 720 along the front surface of the ground vehicle 700. The unmanned ground vehicle 700 may also include a depth sensor 740. The ground vehicle 700 includes multiple wheels 715 along the bottom surface of the ground vehicle 700. The wheels 715 may act as a conveyance of the ground vehicle 700 and may be motorized using one or more motors. The motors, and thus the wheels 715, may be actuated to move the unmanned ground vehicle 700 via a movement actuator. The ground vehicle may also include at least one audio capture device 740 for receiving voice input.

In some aspects, the unmanned ground vehicle 700 can be configured to use voice inputs for various purposes. In this illustrative aspect, the automated cleaning device can provide various information in response to voice input, such as audibly outputting information related to scheduling. The systems and techniques disclosed herein can be used to improve a time at which the unmanned ground vehicle 700 provides feedback based on the authentication. For example, the unmanned ground vehicle 700 may include a LED indicator that provides notice that the speaker is authenticated and permitted to provide input to program various functions of the unmanned ground vehicle 700.

The various aspects disclosed herein are not limiting and the systems and techniques can be applied to another mobile or fixed device. As an illustrative example, the systems and techniques can be applied to an automated teller machine (ATM), an autonomous checkout system, an autonomous drone, and so forth.

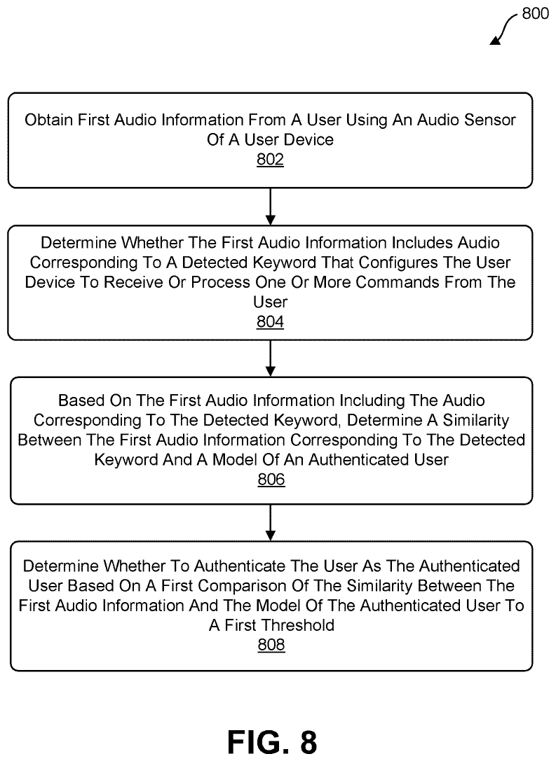

FIG. 8 is a flowchart illustrating an example of a method 800 for processing audio data, in accordance with certain aspects of the present disclosure. The methods 300 and 800 can be performed by a computing device (or a component of the computing device) having an audio capture device, such as a mobile wireless communication device, a smart speaker, a camera, an XR device, a wireless-enabled vehicle, or another computing device. In one illustrative example, a computing system 900 can be configured to perform all or part of the methods 300 and 800.

At block 802, the computing device may obtain first audio information from a user using an audio sensor of a user device. The first audio information can include a keyword that is selected by the user. For example, during setup of voice functions for the computing device, the computing device may receive user input corresponding to selection of text associated with the keyword in the user device. A person can change the keyword for a variety of reasons, such as similarity of names that can confuse the computing device. In other aspects, during setup of voice functions for the computing device, the computing device may prompt the user to provide voice input to learn characteristics associated with the user's voice and train a model of the user's voice that can be used to uniquely identify the user. For example, the computing device can cause another computing device (e.g., a mobile phone) to display content for the user to read aloud. The computing device can also aurally prompt the user for various phrases.

At block 804, the computing device may determine whether the first audio information includes audio corresponding to a detected keyword (e.g., a previously-detected keyword) that configures the user device to receive or process one or more commands from the user. As described above, the keyword can be selected by the user, and the training of the model of the user's voice can include repeating the keyword.

At block 806, the computing device may, based on the first audio information including the audio corresponding to the detected keyword, determine a similarity between the first audio information corresponding to the detected keyword and a model of an authenticated user. The similarity can be a correlation that identifies a likelihood that the first audio information is the user's voice.

At block 808, the computing device may determine whether to authenticate the user as the authenticated user based on a first comparison of the similarity between the first audio information and the model of the authenticated user to a first threshold. In some aspects, the first threshold is a high threshold an requires many characteristics to match to the model of the user voice and provides a high confidence that is unlikely to degrade with additional input. The user can be authenticated using only the first audio information in this case. The first threshold can be used in environments that do not have ambient noise that can affect the first comparison. For example, an environment with higher noise can prevent the first audio information from satisfying the first threshold.

In some aspects, the computing device may not authenticate the user based on the first comparison to the first threshold. For example, if the user is watching a video and there is a significant amount of audio from the video may increase the noise floor and prevent the user from authenticating using the keyword. At this point, the computing device can output an audio indication or a visual indication that the keyword is detected. The user understand the audio or visual indication indicates that the computing device is expecting audio information.

The computing device may then obtain second audio information from the user using the audio sensor of the user device. For example, the second audio information includes a command for the computing device to perform. In one illustrative aspect, the command can be a query (e.g., what is the time, etc.) that does not include the keyword. In one illustrative aspect, the computing device may start a timer for authenticating a portion of the second audio information as further described below. In other aspects, the timer may begin based on the input of the first audio information.

In one aspect, while obtaining the second audio information, the computing device may determine that the second audio information comprises audio having a maximum duration. For example, based on the timer, the computing device can determine that the amount of speech (e.g., second audio information) from the user is equal to the maximum duration. Based on this determination, the computing device may determine a similarity between a portion of the second audio information having the maximum duration and the model of the authenticated user. After determining the similarity, the computing device may then determine whether to authenticate the user as the authenticated user based on a second comparison of the similarity between at least the portion of the second audio information and the model of the authenticated user to a second threshold that is different from the first threshold. In some cases, the similarity between at least the portion of the second audio information and the model of the authenticated user includes a similarity between the model of the authenticated user and a combination of the first audio information and at least the portion of the second audio information (e.g., the keyword and a portion of the command are used in the second comparison). The first comparison and the second comparison can be part of the two-stage text-independent user verification process described above.

In some aspects, the second threshold is lower than the first threshold and provides a sufficient determination based on analyzing a longer portion of speech as compared to the first portion of speech. In one illustrative example, the maximum duration can be 3 seconds. By limiting the amount of speech (e.g., the portion of the second audio information), the computing device can attempt to authenticate the user in parallel with receiving of the second audio information and reduce latency of voice input. Although this example describes the first portion of the second audio information is used for authentication, other examples are possible. For example, a second portion of the second audio information can be determined based on noise information to authenticate other portions of the second audio information.

In some other aspects, the computing device can determine that the second audio information is received before the maximum duration of the timer. For example, for simple queries (e.g., what's the time), the input of the second audio information can end before the maximum duration of the timer. The computing system can, based on the user not being authenticated based on the first audio information, determine a similarity between the second audio information and the model of the authenticated user. The computing system can then determine whether to authenticate the user as the authenticated user based on a third comparison of the similarity between at least the second audio information and the model of the authenticated user to a second threshold that is different from the first threshold. In some cases, the similarity between at least the second audio information and the model of the authenticated user includes a similarity between the model of the authenticated user and a combination of the first audio information and the second audio information (e.g., the keyword and the command are used in the third comparison). As noted above, the first comparison and the second comparison can be part of the two-stage text-independent user verification process described above.

After the input of the second audio information is completed, the computing system may provide the second audio information to an audio processing system for processing based on whether the user is authenticated as the authenticated user. For example, an audio processing system can convert the second audio information into machine readable information such as text. Other forms of machine readable information include extensible markup language (XML) or JavaScript object notation (JSON) that can identify metadata such as uncertainty of words, pitch information, etc. In some aspects, the audio processing system can perform functions such as natural language processing (NLP) function to disambiguate the command and responds to that command. One example of an NLP function is named entity recognition (NER) and identifies entities are words that have a specific meaning, such as the name of a person or the name of a city. Based on the entities in the NLP and further processing of the machine readable information, the audio processing system can attempt to understand the command within the second audio information and form a reply. The computing system can receive the reply from the audio processing system, and then provide a response. For example, the computing system may aurally provide the local time, weather, or other information related to the second audio information.

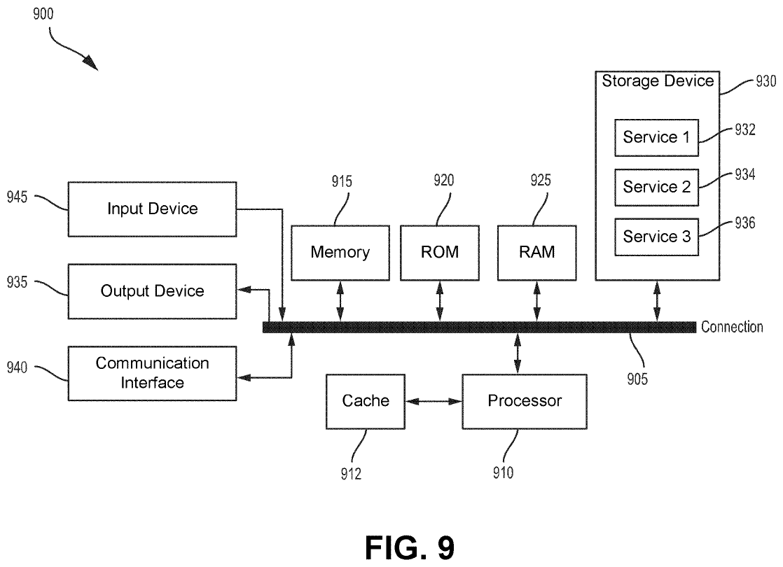

In some examples, the processes described herein (e.g., methods 300 and 800, and/or other process described herein) may be performed by a computing device or apparatus. In one example, the methods 300 and 800 can be performed by a computing device (e.g., image capture and voice input device 200 in FIG. 2) having a computing architecture of the computing system 900 shown in FIG. 9.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the methods described herein, including the methods 300 and 800. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of methods described herein. In some examples, the computing device may include a display, a network interface configured to communicate and/or receive the data, any combination thereof, and/or other component(s). The network interface may be configured to communicate and/or receive IP-based data or other type of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

The methods 300 and 800 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the methods.

The methods 300 and 800, and/or other method or process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 900 includes at least one processing unit (CPU or processor) 910 and connection 905 that couples various system components including system memory 915, such as ROM 920 and RAM 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method of processing audio, comprising: obtaining first audio information from a user using an audio sensor of a user device; determining whether the first audio information includes audio corresponding to a detected keyword that configures the user device to receive or process one or more commands from the user; based on the first audio information including the audio corresponding to the detected keyword, determining a similarity between the first audio information corresponding to the detected keyword and a model of an authenticated user; and determining whether to authenticate the user as the authenticated user based on a first comparison of the similarity between the first audio information and the model of the authenticated user to a first threshold.

Aspect 2. The method of Aspect 1, further comprising: obtaining second audio information from the user using the audio sensor of the user device; and providing the second audio information to an audio processing system for processing based on whether the user is authenticated as the authenticated user.

Aspect 3. The method of Aspect 2, wherein the second audio information includes a command.

Aspect 4. The method of Aspect 3, wherein the command does not include the keyword.

Aspect 5. The method of any one of any of Aspects 2 to 4, further comprising: based on the user not being authenticated based on the first audio information, determining a similarity between the second audio information and the model of the authenticated user; and determining whether to authenticate the user as the authenticated user based on a second comparison of the similarity between at least the second audio information and the model of the authenticated user to a second threshold that is different from the first threshold.

Aspect 6. The method of Aspect 5, wherein the similarity between at least the second audio information and the model of the authenticated user includes a similarity between the model of the authenticated user and a combination of the first audio information and the second audio information.

Aspect 7. The method of any one of Aspects 5 or 6, wherein the first comparison and the second comparison are part of a two-stage text-independent user verification process.

Aspect 8. The method of any one of any of Aspects 2 to 4, further comprising: while obtaining the second audio information, determining that the second audio information comprises audio having a maximum duration; determining a similarity between a portion of the second audio information having the maximum duration and the model of the authenticated user; and determining whether to authenticate the user as the authenticated user based on a second comparison of the similarity between at least the portion of the second audio information and the model of the authenticated user to a second threshold that is different from the first threshold.

Aspect 9. The method of Aspect 8, further comprising determining the second audio information comprises the audio having the maximum duration based on a timer.

Aspect 10. The method of any one of any of Aspects 1 to 9, wherein the model of the authenticated user is based on speech including the detected keyword from the authenticated user.

Aspect 11. The method of any of Aspects 1 to 10, further comprising receiving user input corresponding to selection of text associated with the detected keyword in the user device.

Aspect 12. An apparatus for processing audio. The apparatus includes a memory (e.g., implemented in circuitry) and a processor (or multiple processors) coupled to the memory. The processor (or processors) is configured to: obtain first audio information from a user using an audio sensor of a user device; determine whether the first audio information includes audio corresponding to a detected keyword that configures the user device to receive or process one or more commands from the user; based on the first audio information including the audio corresponding to the detected keyword, determine a similarity between the first audio information corresponding to the detected keyword and a model of an authenticated user; and determine whether to authenticate the user as the authenticated user based on a first comparison of the similarity between the first audio information and the model of the authenticated user to a first threshold.

Aspect 13. The apparatus of Aspect 12, wherein the processor is configured to: obtain second audio information from the user using the audio sensor of the user device; and provide the second audio information to an audio processing system for processing based on whether the user is authenticated as the authenticated user.

Aspect 14. The apparatus of Aspect 13, wherein the second audio information includes a command.

Aspect 15. The apparatus of Aspect 14, wherein the command does not include the keyword.

Aspect 16. The apparatus of any of Aspects 13 to 15, wherein the at least one apparatus is configured to: based on the user not being authenticated based on the first audio information, determine a similarity between the second audio information and the model of the authenticated user; and determine whether to authenticate the user as the authenticated user based on a second comparison of the similarity between at least the second audio information and the model of the authenticated user to a second threshold that is different from the first threshold.

Aspect 17. The apparatus of Aspect 16, wherein the similarity between at least the second audio information and the model of the authenticated user includes a similarity between the model of the authenticated user and a combination of the first audio information and the second audio information.

Aspect 18. The apparatus of any one of Aspects 16 or 17, wherein the first comparison and the second comparison are part of a two-stage text-independent user verification process.

Aspect 19. The apparatus of any of Aspects 13 to 15, wherein the processor is configured to: while obtaining the second audio information, determine that the second audio information comprises audio having a maximum duration; determine a similarity between a portion of the second audio information having the maximum duration and the model of the authenticated user; and determine whether to authenticate the user as the authenticated user based on a second comparison of the similarity between at least the portion of the second audio information and the model of the authenticated user to a second threshold that is different from the first threshold.

Aspect 20. The apparatus of Aspect 19, wherein the processor is configured to: determine the second audio information comprises the audio having the maximum duration based on a timer.

Aspect 21. The apparatus of any of Aspects 12 to 20, wherein the model of the authenticated user is based on speech including the detected keyword from the authenticated user.

Aspect 22. The apparatus of any of Aspects 12 to 21, wherein the processor is configured to: receive user input corresponding to selection of text associated with the detected keyword in the user device.

Aspect 23. The apparatus of any one of Aspects 12 to 22, wherein the apparatus is the user device.

Aspect 24: A non-transitory computer-readable medium comprising instructions which, when executed by one or more processors, cause the one or more processors to perform operations according to any of Aspects 1 to 11.

Aspect 25: An apparatus comprising means for performing operations according to any of Aspects 1 to 11.

1. A method of processing audio, comprising:
obtaining first audio information from a user using an audio sensor of a user device;
determining whether the first audio information includes audio corresponding to a detected keyword that configures the user device to receive or process one or more commands from the user;
based on the first audio information including the audio corresponding to the detected keyword, determining a similarity between the first audio information corresponding to the detected keyword and a model of an authenticated user; and
determining whether to authenticate the user as the authenticated user based on a first comparison of the similarity between the first audio information and the model of the authenticated user to a first threshold.

2. The method of claim 1, further comprising:
obtaining second audio information from the user using the audio sensor of the user device; and
providing the second audio information to an audio processing system for processing based on whether the user is authenticated as the authenticated user.

3. The method of claim 2, wherein the second audio information includes a command.

4. The method of claim 3, wherein the command does not include the keyword.

5. The method of claim further comprising:
based on the user not being authenticated based on the first audio information, determining a similarity between at least the second audio information and the model of the authenticated user; and
determining whether to authenticate the user as the authenticated user based on a second comparison of the similarity between at least the second audio information and the model of the authenticated user to a second threshold that is different from the first threshold.

6. The method of claim 5, wherein the similarity between at least the second audio information and the model of the authenticated user includes a similarity between the model of the authenticated user and a combination of the first audio information and the second audio information.

7. The method of claim 5 or 6, wherein the first comparison and the second comparison are part of a two-stage text-independent user verification process.

8. The method of claim further comprising:
while obtaining the second audio information, determining that the second audio information comprises audio having a maximum duration;
determining a similarity between a portion of the second audio information having the maximum duration and the model of the authenticated user; and
determining whether to authenticate the user as the authenticated user based on a second comparison of the similarity between at least the portion of the second audio information and the model of the authenticated user to a second threshold that is different from the first threshold.

9. (canceled)

10. (canceled)

11. (canceled)

12. An apparatus for processing audio, comprising:
at least one memory; and
at least one processor coupled to at least one memory and configured to:
obtain first audio information from a user using an audio sensor of a user device;
determine whether the first audio information includes audio corresponding to a detected keyword that configures the user device to receive or process one or more commands from the user;
based on the first audio information including the audio corresponding to the detected keyword, determine a similarity between the first audio information corresponding to the detected keyword and a model of an authenticated user; and
determine whether to authenticate the user as the authenticated user based on a first comparison of the similarity between the first audio information and the model of the authenticated user to a first threshold.

13. The apparatus of claim 12, wherein the at least one processor is configured to:
obtain second audio information from the user using the audio sensor of the user device; and
provide the second audio information to an audio processing system for processing based on whether the user is authenticated as the authenticated user.

14. The apparatus of claim 13, wherein the second audio information includes a command.

15. The apparatus of claim 14, wherein the command does not include the keyword.

16. The apparatus of claim 13 to 15, wherein the at least one processor is configured to:
based on the user not being authenticated based on the first audio information, determine a similarity between the at least second audio information and the model of the authenticated user; and
determine whether to authenticate the user as the authenticated user based on a second comparison of the similarity between at least the second audio information and the model of the authenticated user to a second threshold that is different from the first threshold.

17. The apparatus of claim 16, wherein the similarity between at least the second audio information and the model of the authenticated user includes a similarity between the model of the authenticated user and a combination of the first audio information and the second audio information.

18. The apparatus of claim wherein the first comparison and the second comparison are part of a two-stage text-independent user verification process.

19. The apparatus of claim 13 to 15, wherein the at least one processor is configured to:
while obtaining the second audio information, determine that the second audio information comprises audio having a maximum duration;
determine a similarity between a portion of the second audio information having the maximum duration and the model of the authenticated user; and
determine whether to authenticate the user as the authenticated user based on a second comparison of the similarity between at least the portion of the second audio information and the model of the authenticated user to a second threshold that is different from the first threshold.

20. The apparatus of claim 19, wherein the at least one processor is configured to:
determine the second audio information comprises the audio having the maximum duration based on a timer.

21. The apparatus of claim 12 to 20, wherein the model of the authenticated user is based on speech including the detected keyword from the authenticated user.

22. The apparatus of any claim 12 to 21, wherein the at least one processor is configured to: receive user input corresponding to selection of text associated with the detected keyword in the user device.

23. (canceled)

24. A non-transitory computer-readable medium having stored thereon instructions that, when executed by one or more processors, cause the one or more processors to:
obtain first audio information from a user using an audio sensor of a user device; determine whether the first audio information includes audio corresponding to a detected keyword that configures the user device to receive or process one or more commands from the user;
based on the first audio information including the audio corresponding to the detected keyword, determine a similarity between the first audio information corresponding to the detected keyword and a model of an authenticated user; and
determine whether to authenticate the user as the authenticated user based on a first comparison of the similarity between at least the first audio information and the model of the authenticated user to a first threshold.

25. (canceled)

26. (canceled)

27. (canceled)

28. (canceled)

29. (canceled)

30. (canceled)
